(19) United States
(12) Patent Application Publication
(10) Pub. No.: US 2026/0079620 A1
(43) Pub. Date: Mar. 19, 2026

(54) METHOD AND APPARATUS FOR HANDLING STRONGLY-TYPED EVENTS

(71) Applicant: Dell Products L.P., Round Rock, TX (US)

(72) Inventor: Ruben Michel, Hopkinton, MA (US)

(73) Assignee: Dell Products L.P., Round Rock, TX (US)

(21) Appl. No.: 18/889,451

(22) Filed: Sep. 19, 2024

(51) Int. Cl. G06F 3/06

(52) U.S. Cl. CPC G06F 3/0611; G06F 3/0655; G06F 3/067

(57) ABSTRACT

A method for use in a computing device, the method comprising: obtaining an event object; identifying a class that is associated with the event object; identifying an inheritance hierarchy that is associated with the class, the inheritance hierarchy including one or more superclasses that are inherited, directly or indirectly, by the class associated with the event object; for the class associated with the event object and each of the superclasses, identifying a respective set of observer methods, each of the observer methods being an observer method that accepts the event object as an argument; invoking each of the observer methods in any of the sets by using of the event object as an input parameter, each of the observer methods being invoked by using reflection.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided for use in a computing device, the method comprising: obtaining an event object; identifying a class that is associated with the event object; identifying an inheritance hierarchy that is associated with the class, the inheritance hierarchy including one or more superclasses that are inherited, directly or indirectly, by the class associated with the event object; for the class associated with the event object and each of the superclasses, identifying a respective set of observer methods, each of the observer methods being an observer method that accepts the event object as an argument; invoking each of the observer methods in any of the sets by using of the event object as an input parameter, each of the observer methods being invoked by using reflection.

According to aspects of the disclosure, a system is provided, comprising: a memory; and at least one processor that is operatively coupled to the memory, the at least one processor being configured to perform the operations of: obtaining an event object; identifying a class that is associated with the event object; identifying an inheritance hierarchy that is associated with the class, the inheritance hierarchy including one or more superclasses that are inherited, directly or indirectly, by the class associated with the event object; for the class associated with the event object and each of the superclasses, identifying a respective set of observer methods, each of the observer methods being an observer method that accepts the event object as an argument; invoking each of the observer methods in any of the sets by using of the event object as an input parameter, each of the observer methods being invoked by using reflection.

According to aspects of the disclosure, a non-transitory computer-readable medium is provided that stores one or more processor-executable instructions, which, when executed by at least one processor, cause the at least one processor to perform the operations of: obtaining an event object; identifying a class that is associated with the event object; identifying an inheritance hierarchy that is associated with the class, the inheritance hierarchy including one or more superclasses that are inherited, directly or indirectly, by the class associated with the event object; for the class associated with the event object and each of the superclasses, identifying a respective set of observer methods, each of the observer methods being an observer method that accepts the event object as an argument; invoking each of the observer methods in any of the sets by using of the event object as an input parameter, each of the observer methods being invoked by using reflection.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a flowchart of an example of a process, according to aspects of the disclosure;

FIG. 3 is a diagram of an example of an event processing module, according to aspects of the disclosure;

FIG. 4 is a flowchart of an example of a process, according to aspects of the disclosure;

FIG. 5 is a flowchart of an example of a process, according to aspects of the disclosure;

FIG. 6 is a flowchart of an example of a process, according to aspects of the disclosure; and

FIG. 7 is a diagram of an example of a computing device, according to aspects of the disclosure.

### DETAILED DESCRIPTION

Evening is critically important in large-scale client-server systems. For example, if, in a large-scale storage system, a disk fails, the server must immediately notify all connected clients. If a disk is approaching full capacity, if a director fails, if a power supply fails, or if a memory board fails, the server must similarly notify all connected clients. Currently, in some conventional storage systems, the client periodically polls the server using HTTPS to retrieve server events. Polling is not only inefficient but also delays the event's arrival. For this reason, the need exists for an improved approach for eventing that does not depend on polling, and which could be used in places where polling is currently used for event handling.

The present disclosure provides a method for implementing eventing in strongly-typed systems. The approach uses strong typing. For small projects, weakly-typed evening is often acceptable. However, as the project grows, strongly typed events become mandatory. Currently, there are advanced client-eventing frameworks and advanced server eventing frameworks, whereby the client-eventing frameworks are strongly typed and the server eventing frameworks are strongly typed. However, solutions that bridge these two types of frameworks are rare. In other words, solutions that maintain adherence to strong-typed events across the divide that separates the client from the server are rare. In this regard, the eventing solution examples of which are disclosed throughout the disclosure can be used both on the server-side and the client-side, and is thus capable of bridging the gaps between the client-eventing and server-eventing frameworks that exist in many large-scale systems. In some implementations, the solution may utilize a translation layer on the server side that is arranged to translate the syntax for events that is supported on the client side to the syntax that is supported at the server.

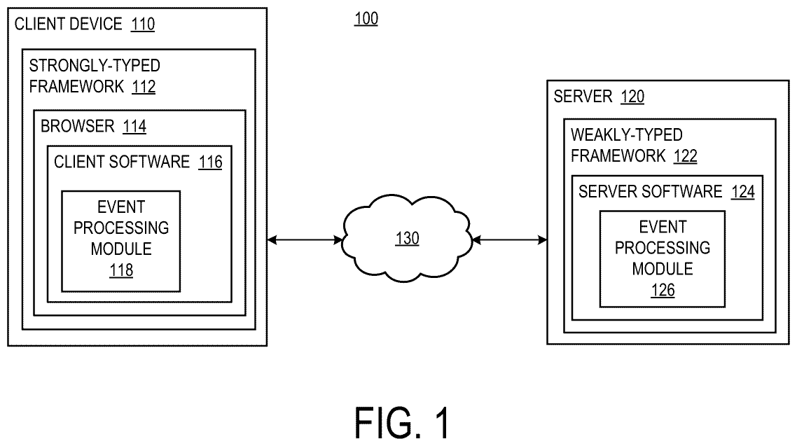

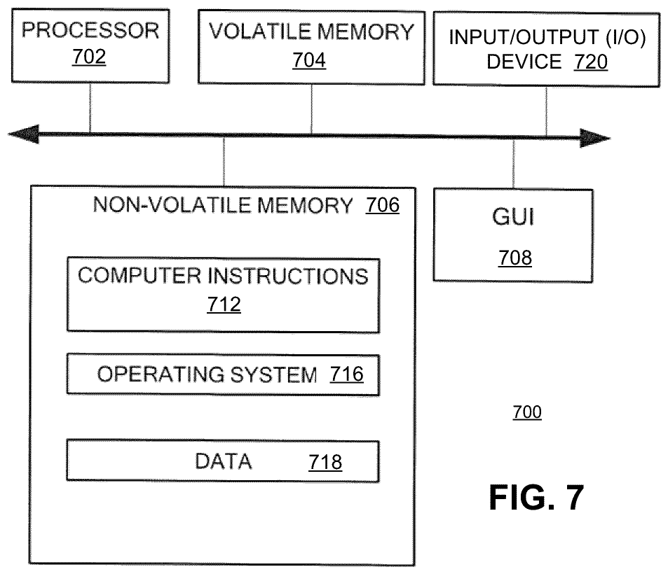

FIG. 1 is a diagram of an example of a system 100, according to aspects of the disclosure. As illustrated, system 100 may include a client 110 and a server 120. Client 110 may include any suitable type of computing device, such as the computing device 700, which is discussed further below with respect to FIG. 7. Server 120 may include any suitable computing device, such as the computing device 700, which is discussed further below with respect to FIG. 7. In one example, client 110 may be used to implement a management console of a storage system, and the server 120 may be executed on any of the storage processors that make up the storage system. However, the present disclosure is not limited to any specific implementation of client 110 and/or server 120.

The client 110 and the server 120 may be coupled to each other via a communications network 130. The communications network 130 may include any suitable type of network. By way of example, the network 130 may include one or more of the Internet, a local area network (LAN), a wide area network (WAN), a wireless network, an Ethernet network, an InfiniBand network, a Fibre Channel network, and/or any other suitable type of network.

The client 110 may be configured to execute a strongly typed framework 112, a browser 114, client software 116, and an event processing module 118. According to the present example, the strongly-typed framework 112 may include a Typescript engine and/or any other suitable type engine that supports strong typing such as Google Dart, Opal Kolin/JS, PureScript, Scala.js, and ClojureScript, for example. Browser 114 may include any suitable type of web browser, such as Opera ™, Firefox ™, and Microsoft Edge ™, for example. The client software 116 may include any suitable type of software that is at least partially executed within browser 114, such as a web-based application, for example. The event processing module 118 may include software that is configured to fire events that are generated within the client 110. Event processing module 118 may be implemented as a set of processor-executable instructions that are executed by a processor of the client 110. Although, in the example of FIG. 1, the event processing module 118 is depicted as a monolithic block, it will be understood that in some implementations, different portions of event processing module 118 may be part of different components of the software environment of the client 110.

Server 120 may be configured to execute a strongly-typed framework 122, server software 124, and an event processing module 126. Framework 122 may be the Jakarta Enterprise Edition (JEE) framework and/or any other suitable type of framework, such as Spring, Quarkus, and Micronaut, for example. The server software 124 may include any suitable type of software that is configured to interact with the client software 116. The event processing module 126 may include software that is configured to fire events that are generated within server 120. Event processing module 126 may be implemented as a set of processor-executable instructions that are executed by a processor of server 120. Although, in the example of FIG. 1, the event processing module 126 is depicted as a monolithic block, it will be understood that in some implementations, different portions of event processing module 126 may be part of different components of the software environment of the server 120.

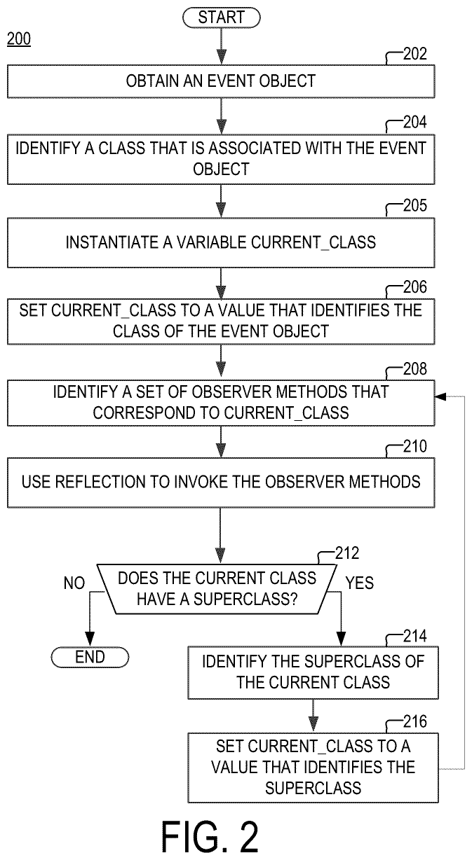

FIG. 2 is a flowchart of an example of a process 200, according to aspects of the disclosure. According to the present example, process 200 is performed by module 118. However, the present disclosure is not limited to any specific entity or set of entities executing process 200. For example, in some implementations, process 200 may be performed by module 126.

At step 202, module 118 obtains an event object. The event object may have a specific type and it may contain a payload. Under the nomenclature of the present disclosure, the payload is also referred to as a “message”. The message may include any suitable type number, string, or alphanumerical string or arbitrary class instance. The message may contain information that is useable by one or more components of the software environment of client 110 and/or one or more components of the software environment of server 120. Stated succinctly, the message may contain information that is usable by one or more processes that are executed on client 110 and/or one or more processes that are executed on server 120. In instances in which system 100 includes multiple client devices or multiple servers, the message may contain information that is usable by one or more processes that are executed on any of the other client devices or servers.

At step 204, module 118 identifies a class that is associated with the event. As can be readily appreciated, identifying the class may include identifying the type of the event object.

At step 205, module 118 instantiates a variable current_class.

At step 206, module 118 sets current_class to a value that identifies the class that is associated with the event.

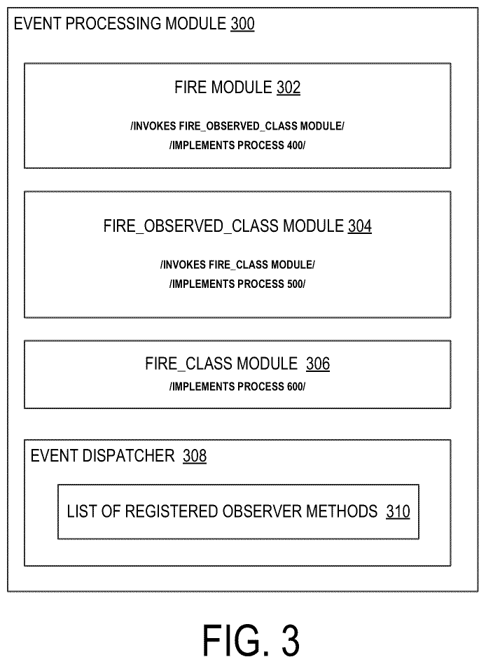

At step 208, module 118 identifies a set of observer methods that correspond to current_class. According to the present example, the set includes one or more observer methods. In some implementations, each of the observer methods may be an observer method that accepts as one of its input parameters event objects that have the same type as the event object obtained at step 202. In some implementations, none of the observer methods may be an observer method that does not accept, as input parameters, event objects that have the same type as the event object obtained at step 202. In some implementations, the set of observer methods may include each and every observer method that is registered in the list 310 (discussed further below with respect to FIG. 3), which accepts as input event objects that have the same type as the event object obtained at step 202.

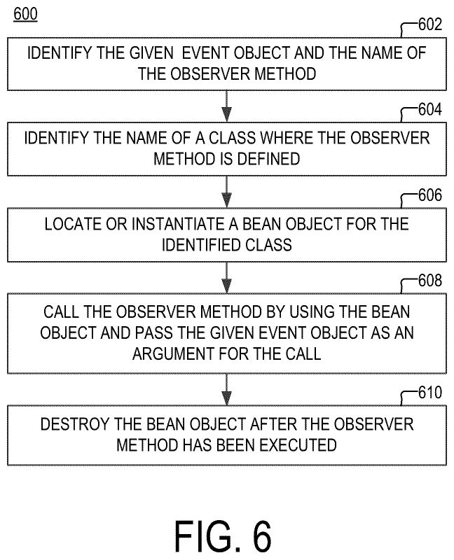

At step 210, module 118 uses reflection to invoke each of the methods (identified at step 208). In the context of Java and other programming languages, reflection is a feature that allows a program to inspect and manipulate its classes at runtime. Using reflection, allows the modifications of the runtime behavior of applications, access to private methods and fields, the invocation of methods, and the creation of instances of classes that may not be known until runtime. In the present case, reflection is used because the instances of classes that accept the type of the event object (obtained at step 202) may be specified by external configurations (such as that of server 120). In some implementations, each of the observer methods is invoked in accordance with a process 600, which is discussed further below with respect to FIG. 6.

According to the present example, module 118 invokes each of the observer methods by performing the following steps: First, module 118 obtains the name of the class of which the observer method is part. Next, module 118 obtains a bean object for the class. Next, module 118 calls the observer method by using the bean object. In invoking the method, module 118 passes the event object (obtained at step 202) as one of the parameters of the call.

At step 212, module 118 determines if current_class has a superclass. In other words, module 118 determines if the class identified by the value of variable current_class has a superclass. More particularly, in one example, module 118 may determine whether there exists a class from which the class identified by variable current_class extends directly. If current_class does not have a superclass, process 200 ends. Otherwise, if current_class has a superclass, process 200 proceeds to step 214. At step 214, module 118 gets the superclass of current_class. At step 216, module 118 sets current_class to equal the superclass that is obtained at step 214.

After step 216 is completed, process 200 proceeds to step 214.

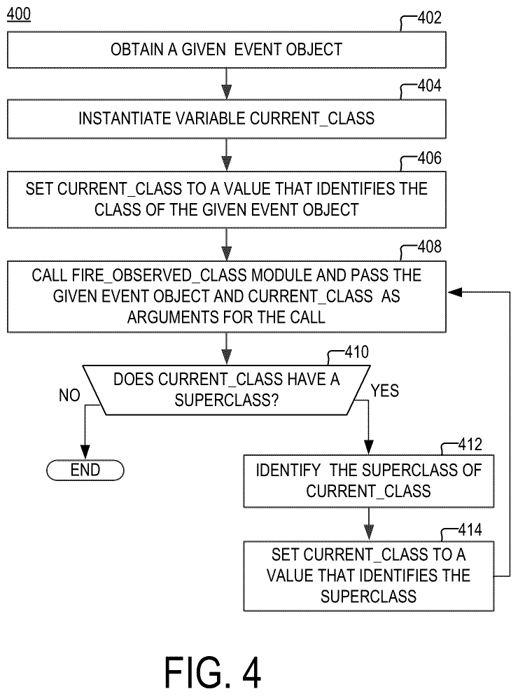

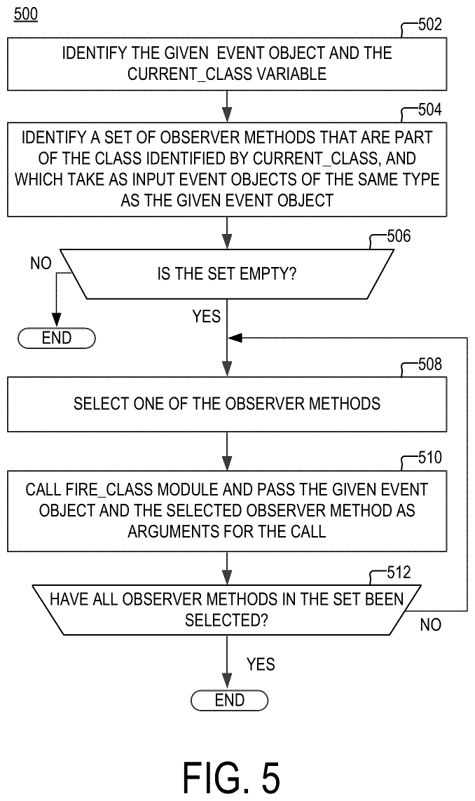

FIG. 3 is a diagram of an example of an event processing module 300 (hereinafter “module 300”), according to aspects of the disclosure. Module 300 may be the same or similar to any of module 118 and module 126. As illustrated, module 300 may include a fire module 302 (hereinafter “module 302”), a fire_observed_class module 304 (hereinafter “module 304”), a fire_class module 306 (hereinafter “module 306), and an event dispatcher 308. Module 302 may include one or more processor-executable instructions, which, when executed by at least one processor, cause the at least one processor to traverse the inheritance tree of a message object and place a different respective call to module 304 for the message object and each superclass of the message object. In some implementations, module 302 may be configured to implement a process 400, which is discussed further below with respect to FIG. 4. Module 304 may include one or more processor-executable instructions, which, when executed by at least one processor, cause the at least one processor to identify a set of observer methods for a given class and place a different respective call to module 306 for each of the observer methods. In some implementations, module 304 may be configured to implement a process 500, which is discussed further below with respect to FIG. 5. Module 306 may include one or more processor-executable instructions, which, when executed by at least one processor, cause the at least one processor to use reflection to execute an observer method for the message object. In some implementations, module 306 may be configured to implement a process 600, which is discussed further below with respect to FIG. 6. Although, in the example of FIG. 3, each of modules 302-306 is implemented in software, alternative implementations are possible in which at least one of modules 302-306 is implemented in hardware or as a combination of software and hardware.

Event dispatcher 308 may include one or more processor-executable instructions for handling events. The event dispatcher 308 may contain a list 310 of observer methods that are registered with it. Each of the observer methods may be implemented as part of a particular message class, and it may be strongly-typed, meaning that the method signature specifies the types of objects the observer method would take as input and a compile error would be raised if the user attempts to compile code which places calls to the observer method that include unsupported types of event objects. The event dispatcher 308 may be configured to provide an application programming interface (API) or other facilities for responding to a query that is submitted by module 304. The query may include an indication of a type of event object. In response to the query, the event dispatcher may perform a search of the list of observer methods that are returned to it and compile a new list that includes only those of the registered observer methods that support receiving as input the event object type identified in the query. Afterwards, the event dispatcher 308 may return the list to module 304. Although, in the example of FIG. 3, the modules 302-306 and event dispatcher 308 are represented by separate blocks, it will be understood that in some implementations the modules 302-306 may be implemented as part of event dispatcher 308.

Each of the observer methods that are registered with event dispatcher 308 may be a method that is configured to receive an event object and perform a particular action (or set of actions) based on the event object. By way of example, the action may include storing a message that is contained in the event object in a log file. As another example, the action may include transmitting a message to a remote device. For example, when event processing module 300 is executed on a client device, such as client 110 (shown in FIG. 1), the message may be transmitted to one or more servers (such as server 120) or one or more other client devices. Similarly, when event processing module 300 is executed on a server (such as server 120), the message may be transmitted to one or more other servers or one or more client devices (such as client device 110). Additionally or alternatively, the action may include invoking another method that is executed on the same computing device as event processing module 300 or on a remote device. Invoking the other method may include providing information that is contained in the event object (which was submitted as input to the observer method) to the other method as input, and executing the other method based on the information. In some implementations, when the other method is executed on a remote device all communications between the device executing the event processing module 300 and the device executing the other method may be performed by using WebSockets or any other suitable type of full-duplex communications protocol.

In general, observer methods are well understood by those of ordinary skill in the art. The present disclosure is not limited to any specific type of observer method being used. Although, the term “observer method” is native to programming languages such as Java, Python, and TypeScript, it will be understood that the present disclosure uses the term “observer method” to refer to any suitable type of listener that is executed in response to an event, irrespective of the programming language used.

FIG. 4 is a diagram of an example of a process 400, according to aspects of the disclosure. At step 402, module 302 obtains a given event object. The given event object may be the same or similar to the event object that is discussed above with respect to FIG. 2. At step 404, module 302 instantiates a variable current_class. At step 406, module 302 sets variable current_class to a value that identifies a class that is associated with the given event object (e.g., the class (and/or type) of the event object). At step 408, module 306 places a call to module 304. The given event object (obtained at step 402) and variable current_class are passed as arguments for the call. At step 410, module 302 determines if current_class has a superclass. According to the resent example, module 302 determines if there exists a class that is inherited directly by the class that is identified by the value of variable current_class. If current_class does not have a superclass, process 400 ends. Otherwise, if current_class has a superclass, process 400 proceeds to step 412. At step 412, module 304 identifies the superclass of current_class. At step 414, module 302 sets current_class to a value that identifies the superclass (identified at step 414). In some implementations, current_class may be an object that contains information about the superclass (or the event object class), such as the name of the superclass. Alternatively, in some implementations, current_class may be an alphanumerical string that identifies the name of the superclass (or event object class).

The example of FIG. 4 assumes that a class can have only one super-class. However, alternative implementations are possible in which a class can directly extend from multiple super-classes. In such instances, steps 406-412 may be executed for each and every super-class of the class that is represented by variable current_class. In other words, in some implementations, process 400 may be implemented such that step 408 is executed for each and every super-class in the inheritance hierarchy of the class corresponding to the event object (obtained at step 402). In some implementations, step 412 may identify a super-class that is directly inherited by the class represented by variable current_class. Inheritance is a well-understood by those of ordinary skill in the art. When a class inherits a super class, the class may gain access to attributes and methods of the super-class.

FIG. 5 is a flowchart of an example of a process 500, according to aspects of the disclosure. According to the present example, process 500 is executed in response to a call being placed to module 304 at step 408 of process 400. As noted above, the call may include the given event object (obtained at step 402) and variable current_class (set at step 414 or step 406) as arguments. At step 502, module 304 identifies the given event object and the value of variable current_class, which are submitted as input to module 304. At step 504, module 304 identifies a set of observer methods. Each of the identified observer methods is: (i) part of the event class that is identified by variable current_class, and (ii) accepts event objects that are of the same type as the given event object. In some implementations, each of the identified observer methods may be a strongly-typed method, whose definition explicitly provides that the observer method accepts event object that belong to the same object type as the given event object (obtained at step 402). In some implementations, the set of observer methods may be identified by submitting a query to event dispatcher 308 in the manner discussed above with respect to FIG. 3. Additionally or alternatively, in some implementations, the set of observer methods may include each and every observer method that is registered in list 310, which accepts, as an input parameter, event objects that have the same type as the event object (obtained at step 202). Additionally or alternatively, in some implementations, the set of observer methods may be free of any observer methods that do not accept, as an input parameter, event objects that have the same type as the event object (obtained at step 202).

In some implementations, identifying the set of observer methods may include receiving a set of one or more alphanumerical strings, where each string is the name of a different observer method. For example, and without limitation, each string may only identify the name of an observer method, while lacking other information that could be used to identify a memory location where an object providing the method is instantiated. In other words, each provided string should be distinguished from a pointer to an object which could be referenced for the purpose of placing a call to the observer method. Alternatively, in some implementations, identifying the set of observer methods may include receiving a set of objects, wherein each of the objects contains a string representing the name of an observer method and another string that represents the name of the class that contains the observer method. As in the example above, semantically, each of the strings may identify only the object or class name, and it should be distinguished from a pointer or other reference to a memory location where the method (or object implementing the method) is instantiated.

At step 506, module 304 determines if the set obtained at step 504 is empty. If the set is empty, process 500 ends. Otherwise, process 500 process 500 proceeds to step 508. At step 508, module 304 selects one of the observer methods in the set. The selected observer method may be one that has not been selected during a previous iteration of step 508. At step 510, module 304 calls module 306 and passes the given event (obtained at step 402) and the observer method (obtained at step 508) as arguments for the call (which in turn causes the observer method to be called by using the given event object as an argument for the call). As noted above, in some implementations, module 304 may pass to module 306 an alphanumerical string representing the name of the observer method or an object that includes an alphanumerical string representing the name of the method and another alphanumerical string that represents the name of the class of which the method is part. At step 512, module 304 determines if all observer methods in the set have been processed. If each of the observer methods in the set (identified at step 504) has already been selected once (at step 508), process 500 ends. If there are observer methods in the set which have not yet been selected at step 508, process 500 returns to step 508 where one of the remaining observer methods is selected.

FIG. 6 is a flowchart of an example of a process 600, according to aspects of the disclosure. According to the present example, process 500 is executed in response to a call being placed to module 304 at step 510 of process 500. As noted above, the call may include the given event object (obtained at step 402) and the observer method (selected or step 508) as arguments. The observer method may be represented by a string identifying the name of the method or by an object that contains the name of the method, as well as the name of the class which implements the method. At step 602, module 306 identifies the name of the given event object and the name of the observed method that are passed as input to module 306. At step 604, module 306 identifies the name of the class where the observer method is defined. At step 606, module 306 locates or instantiates a bean object for the class that is identified at step 606. At step 608, module 306 places a call to the observer method by using the bean object. At step 610, the bean object (obtained at step 606) is destroyed. According to the present example, step 610 is performed after the observer method (called at step 608) is executed.

In some respects, FIGS. 4-6 provide an example of a method that involves: (i) traversing the inheritance hierarchy of an event object class, (ii) identifying a plurality of observer method sets, wherein one of the methods sets includes observer methods that are part of the message object class, and each of the remaining method sets includes only observer methods that are part of a different one of the super-classes of the event object class, and (iii) calling the observer methods in each of the method sets by using reflection. As noted above, in some implementations, step (i) may be performed by executing process 400 of FIG. 4; step (ii) may be performed by executing process 500 of FIG. 5; and step (iii) may be performed by executing process 600 of FIG. 6. In some implementations, process 500-600 may be performed by one or more of a TypeScript runtime engine, a Java runtime engine, and/or any other suitable type of runtime engine that supports strong typing.

In some respects, traversing the inheritance hierarchy is advantageous because there may be observer methods in super-classes which also listen for events that have the same type as the event object (obtained at step 402). If such observer methods are not called, the event may not be handled properly by parts of the system as it would reach fewer than all of its intended/requisite destinations. This approach is suitable in systems that employ contravariant event handling, where a method may have parameters that are super-classes of those in the delegated type.

In some respects, the observer methods in any event object class or superclass may be identified using the reflection subsystem of the runtime engine that is executing process 500. Any of the observer methods may be executed on the same computing device that is executing process 500 or it may be executed on a remote device. The observer methods may be discovered when the system first starts up and the dispatcher 308 may be updated to include a list 310 of the discovered observer methods. The discovery may be handled by the language support (e.g., by the TypeScript engine or another similar engine). Alternatively, in some implementations, the list 310 may be populated manually by an administrator or system developer.

Identifying the observer methods that support the event object type before reflection is used to place calls to various observer methods for the event is advantageous because it ensures that only observer methods that support the event object type would be called by using reflection. Observer method calls that are made using reflection are inherently weak-typed. Accordingly, no compile errors would be raised if an attempt is made to pass the wrong message type to an observer method that is being called by using reflection. For this reason, a separate type-checking step is performed (e.g., by executing process 500) before reflection is used (in process 600) to make observer method calls for the event object. In some respects, using reflection is advantageous because classes (or objects) which are located either locally (or at a remote device) may not be accessible directly. In this regard, the approach presented with respect to processes 400-600 is suitable for use in large-scale distributed systems, where different objects may be instantiated in different devices that are part of the system and may not be readily accessible from the device where the initial event handling is performed. In some implementations, processes 400-600 may be used to implement a strongly-typed Context Dependency Injection.

Referring to FIG. 7, in some embodiments, a computing device 700 may include processor 702, volatile memory 704 (e.g., RAM), non-volatile memory 706 (e.g., a hard disk drive, a solid-state drive such as a flash drive, a hybrid magnetic and solid-state drive, etc.), graphical user interface (GUI) 708 (e.g., a touchscreen, a display, and so forth) and input/output (I/O) device 720 (e.g., a mouse, a keyboard, etc.). Non-volatile memory 706 stores computer instructions 712, an operating system 716 and data 718 such that, for example, the computer instructions 712 are executed by the processor 702 out of volatile memory 704. Program code may be applied to data entered using an input device of GUI 708 or received from I/O device 720.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method for use in a computing device, the method comprising:
obtaining an event object;
identifying a class that is associated with the event object;
identifying an inheritance hierarchy that is associated with the class, the inheritance hierarchy including one or more superclasses that are inherited, directly or indirectly, by the class associated with the event object;
for the class associated with the event object and each of the superclasses, identifying a respective set of observer methods, each of the observer methods being an observer method that accepts the event object as an argument;
invoking each of the observer methods in any of the sets by using of the event object as an input parameter, each of the observer methods being invoked by using reflection.

2. The method of claim 1, wherein at least one of the observer methods in any of the sets includes an observer method that is executed of a remote device.

3. The method of claim 1, wherein the computing device is part of a system that uses parameter contravariance.

4. The method of claim 1, wherein invoking each of the observer methods in any of the sets includes obtaining a bean object for a class where the observer method is defined and using the bean object to invoke the observer method.

5. The method of claim 1, wherein the respective set of observer methods for any of the superclasses, and the class associated with the event object, includes one or more observer methods.

6. The method of claim 1, wherein the respective set of observer methods for any of the superclasses, and the class associated with the event object, is identified by using an event dispatcher of the computing device.

7. The method of claim 1, wherein identifying the inheritance hierarchy includes identifying each and every superclass that is inherited, directly or indirectly, by the class associated with the event object.

8. The method of claim 1, wherein none of the identified sets of observer methods includes observer methods that do not accept the event object as an input parameter.

9. A system, comprising:
a memory; and
at least one processor that is operatively coupled to the memory, the at least one processor being configured to perform the operations of:
obtaining an event object;
identifying a class that is associated with the event object;
identifying an inheritance hierarchy that is associated with the class, the inheritance hierarchy including one or more superclasses that are inherited, directly or indirectly, by the class associated with the event object;
for the class associated with the event object and each of the superclasses, identifying a respective set of observer methods, each of the observer methods being an observer method that accepts the event object as an argument;
invoking each of the observer methods in any of the sets by using of the event object as an input parameter, each of the observer methods being invoked by using reflection.

10. The system of claim 9, wherein at least one of the observer methods in any of the sets includes an observer method that is executed of a remote device.

11. The system of claim 9, wherein the computing device is part of a system that uses parameter contravariance.

12. The system of claim 9, wherein invoking each of the observer methods in any of the sets includes obtaining a bean object for a class where the observer method is defined and using the bean object to invoke the observer method.

13. The system of claim 9, wherein the respective set of observer methods for any of the superclasses, and the class associated with the event object, includes one or more observer methods.

14. The system of claim 9, wherein the respective set of observer methods for any of the superclasses, and the class associated with the event object, is identified by using an event dispatcher of the computing device.

15. The system of claim 9, wherein identifying the inheritance hierarchy includes identifying each and every superclass that is inherited, directly or indirectly, by the class associated with the event object.

16. The system of claim 9, wherein none of the identified sets of observer methods includes observer methods that do not accept the event object as an input parameter.

17. A non-transitory computer-readable medium storing one or more processor-executable instructions, which, when executed by at least one processor, cause the at least one processor to perform the operations of:
obtaining an event object;
identifying a class that is associated with the event object;
identifying an inheritance hierarchy that is associated with the class, the inheritance hierarchy including one or more superclasses that are inherited, directly or indirectly, by the class associated with the event object;
for the class associated with the event object and each of the superclasses, identifying a respective set of observer methods, each of the observer methods being an observer method that accepts the event object as an argument;
invoking each of the observer methods in any of the sets by using of the event object as an input parameter, each of the observer methods being invoked by using reflection.

18. The non-transitory computer-readable medium of claim 17, wherein at least one of the observer methods in any of the sets includes an observer method that is executed of a remote device.

19. The non-transitory computer-readable medium of claim 17, wherein the computing device is part of a system that uses parameter contravariance.

20. The non-transitory computer-readable medium of claim 17, wherein invoking each of the observer methods in any of the sets includes obtaining a bean object for a class where the observer method is defined and using the bean object to invoke the observer method.
